(19) United States
(12) Patent Application Publication
(10) Pub. No.: US 2024/0117283 A1
(43) Pub. Date: Apr. 11, 2024

(54) OKRA LIQUOR AND BREWING PROCESS THEREOF

(71) Applicant: SHUYANG COUNTY SANSHAN DISTILLERY, Suqian City (CN)

(72) Inventors: Congyin Zhong, Suqian City (CN); Qili Zhong, Suqian City (CN); Qihang Zhong, Suqian City (CN)

(21) Appl. No.: 18/220,906

(22) Filed: Jul. 12, 2023

(30) Foreign Application Priority Data
Oct. 9, 2022 (CN) 202211226872.0

(51) Int. Cl. C12G 3/022; C12G 3/055

(52) U.S. Cl. CPC C12G 3/022; C12G 3/055

(57) ABSTRACT

The present disclosure discloses an okra liquor, which uses okra seeds as a raw material, and also comprises sorghum, corn, glutinous rice, and Job's tears. By employing a new brewing process, the unique ingredients of the okra seeds are dissolved into liquor, making the liquor more nutritious and improving the previous process of making the okra liquor, directly using the okra seeds into liquor is cleaner and healthier than using okra, the nutritional ingredients of the okra seeds are fully used in the brewing process, and reasonable utilization of the okra seeds makes it easier for the human body to absorb the nutritional components of the okra seeds.

### CROSS REFERENCE TO RELATED APPLICATIONS

This application takes priority and claims the benefit of Chinese Patent Application No. 202211226872.0 filed on Oct. 9, 2022, the contents of which are herein incorporated by reference.

### TECHNICAL FIELD

The present disclosure relates to the field of brewing technology, in particular to an okra liquor and a brewing process thereof.

### BACKGROUND

Okra is also known as yellow okra or coffee okra in the Malvaceae family, with a popular name of sheep's horn beans, cucumbers, etc., and the okra seeds grown therein are rich in protein, oxalic acid, and other substances. Okra is generally used as a vegetable for frying, boiling, cold mixing, canning, soup making, and frozen processing, and the okra seeds are extracted to obtain oil, protein or a substitute for coffee. Its functional characteristics are mainly reflected in two aspects of high nutritional value and significant health and therapeutic effects. Okra not only has health benefits for the heart, stomach, and skin, but also has anti fatigue effects. At present, some people soak okra in a liquor to make an okra liquor. In this way, the efficacy of the okra is greatly reduced. Some people also use the okra to make the liquor, but the use of fresh okra with shells has the following disadvantages: first, the pesticides, dust, bacteria and the like are not cleaned; second, the processed okra is added during the fermentation process, which results in insufficient utilization of okra proteins, oxalic acid, and other substances and is not conducive to human absorption. The okra seeds can eliminate fatigue, effectively restore physical strength, and enhance the body's immune system; the okra seeds contain a lot of mucus, which can maintain the smoothness of articular membrane and prevent the accumulation of arterial blood; and the okra seeds can reduce blood sugar, which is also the first choice for patients with diabetes, and with the effect of regulating blood lipids, the okra seeds can effectively discharge toxic substances from the body, maintain the normal secretion of insulin, balance blood sugar, etc. However, most of the current okra seeds are directly used with the okra, and larger okra will be consumed after the seeds are removed, resulting in waste of the okra seeds. Using the okra seeds for brewing liquor can make more full use of their active ingredients and be absorbed by the human body. Currently, the okra seeds are less commonly used for brewing the liquor.

### SUMMARY

The purpose of the present disclosure is to provide an okra liquor and a brewing process thereof, using okra seeds for brewing can enable the effective ingredients to be more fully utilized and absorbed by the human body, and solve the problem of insufficient utilization of okra seed value.

To achieve the above objectives, the present disclosure provides the following technical solution:

An okra liquor, including the following raw materials in parts by weigh: 20-40 parts of okra seeds, 60-100 parts of sorghum, 10-30 parts of corn, 5-20 parts of glutinous rice, 5-20 parts of Job's tears, and 50-80 parts of clear water.

As a further solution of the present disclosure, including the following raw materials in parts by weigh: 20 parts of okra seeds, 60 parts of sorghum, 10 parts of corn, 5 parts of glutinous rice, 5 parts of Job's tears, and 60 parts of clear water.

As a further solution of the present disclosure, including the following raw materials in parts by weigh: 30 parts of okra seeds, 80 parts of sorghum, 20 parts of corn, 10 parts of glutinous rice, 10 parts of Job's tears, and 50 parts of clear water.

As a further solution of the present disclosure, including the following raw materials in parts by weigh: 40 parts of okra seeds, 100 parts of sorghum, 30 parts of corn, 20 parts of glutinous rice, 20 parts of Job's tears, and 40 parts of clear water.

A brewing process of an okra liquor includes the following steps:

Step 1): Material Selection

Weighing a quantitative amount of okra seeds, sorghum, corn, glutinous rice, and Job's tears, and cleaning with clear water to remove dust and impurities on the surface;

Step 2): Drying and Sterilization

Using a drying oven to sterilize and dry the spare raw materials in Step 1), and controlling the temperature of the drying oven at 110-160° C.;

Step 3): Crushing

Crushing the dried and sterilized raw materials using a grinder, with a particle size of 10 mesh after crushing;

Step 4): Mixing

Adding the crushed raw materials in Step 3) to the clear water at a temperature of 20-28° C., and stirring at a constant speed for 20 minutes using a mixer;

Step 5): Cooking

Putting the well mixed raw materials of Step 4) into a steamer and cooking for 40-60 minutes, with a temperature controlled at 100-120° C., until the raw materials are fully steamed;

Step 6): Cooling and Drying

Placing the raw materials after cooking in Step 5) in a sterile room for cooling, or cooling by using external wind to reduce the temperature to 26° C., after cooling, drying them appropriately and controlling a moisture content of the raw materials to 60-70%;

Step 7): Mixing Koji

performing koji mixing on the raw materials with adjusted humidity and putting the raw materials into a fermentation tank, covering the raw materials with clean kraft paper and a food grade plastic film, fermenting for 35 to 90 days for lipidation;

Step 8): Distillation

Putting the fermented raw materials into a steamer for steaming, and extracting the original liquor;

Step 9): Storage

Placing raw liquor into the liquor jar and stored in the liquor cellar. Controlling a temperature of the liquor cellar at 10-20° C. and a humidity at 60-80° C. to make it mature, fragrant, and odorless. The flavor of liquor is mainly composed of fatty acids and other microorganisms. During the storage of liquor, fatty acid reactions constantly occur to produce substances with aromatic smell, so that the liquor becomes more mellow. When the microbial reactions such as fatty acids stop, the liquor is in the best drinking period. The storage time is for three years.

Compared with prior art, the beneficial effects of the present disclosure are: the present disclosure uses a new technology of making the liquor from the okra seeds, dissolves the unique ingredients of the okra seeds into the liquor, so that the liquor is more nutritious; and the previous technology of making the okra liquor is improved, the okra seeds are directly placed into the liquor, which is cleaner and healthier than using the okra, and the nutritional ingredients of the okra seeds are fully used in the process of making liquor, making reasonable use of the okra seeds, and the nutritional components of the okra seeds are more easily absorbed by the human body.

### DETAILED DESCRIPTION OF THE EMBODIMENTS

The technical solution of the present disclosure will be described in detail below in combination with specific implementation modes. Obviously, the described embodiments are merely a part of the embodiments of the present disclosure but not all. Based on the embodiments in the present disclosure, all other embodiments obtained by those of ordinary skill in the art without contributing creative labor fall within the scope of protection of the present disclosure.

### Example 1

An okra liquor included the following raw materials in parts by weight: 20 parts of okra seeds, 60 parts of sorghum, 10 parts of corn, 5 parts of glutinous rice, 5 parts of Job's tears, and 60 parts of clear water.

A method for brewing the aforementioned okra liquor included the following steps:

Step 1): Material Selection

200 KG of okra seeds, 600 KG of sorghum, 100 KG of corn, 50 KG of glutinous rice, and 50 KG of Job's tears were weighed, and cleaned with clear water to remove dust and impurities on the surface;

Step 2): Drying and Sterilization

A drying oven was used to sterilize and dried the spare raw materials in Step 1), the temperature of the drying oven was dried at 120° C. to keep the surface of the raw materials free from any residual water stains;

Step 3): Crushing

The dried and sterilized raw materials were crushed using a grinder, with a particle size of 10 mesh after crushing;

Step 4): Mixing

25° C. clear water was added to the crushed raw material in Step 3), after mixing, hold tightly and loosed into a scattered state, a mixer was used to stir at a constant speed for 20 minutes;

Step 5): Cooking

The well mixed ingredients of Step 4) was put into a steamer and steam for 40 minutes, the temperature was controlled at 100° C., and steamed thoroughly, after steaming thoroughly, there was no hardness feel to the hand and no paste;

Step 6): Cooling and Drying

The steamed raw materials in Step 5) were placed in a sterile room for cooling, external wind was used to cool, the temperature was reduced to 26° C., after cooling, the raw materials are dried, and the water content of the raw materials was controlled to 60%;

Step 7): Mixing Koji

The raw materials with adjusted humidity were subjected to koji mixing and put into a fermentation tank, covered with clean kraft paper and a food grade plastic film, fermented for 35 to 90 for lipidation;

Step 8): Distillation

The fermented raw materials were put into a steamer for steaming, and the raw liquor was extracted;

Step 9): Storage

The raw liquor was put into a liquor jar and stored in a liquor cellar. The temperature of the liquor cellar was controlled at 10-20° C. and the humidity was controlled at 60-80° C. to make it mature, fragrant, and odorless. The flavor of liquor is mainly composed of fatty acids and other microorganisms. During the storage of liquor, fatty acid reactions constantly occur to produce substances with aromatic smell, so as to make the liquor more mellow. When the reaction of fatty acids and other microorganisms stops, the liquor was in the best drinking period, and the storage time is at least 3 years, The specific storage time was controlled according to actual requirement, and the longer the storage time, the better the quality.

### Example 2

An okra liquor included the following raw materials in parts by weight: 30 parts of okra seeds, 80 parts of sorghum, 20 parts of corn, 10 parts of glutinous rice, 10 parts of Job's tears, and 50 parts of clear water.

A method for brewing the aforementioned okra liquor included the following steps:

Step 1): Material Selection

300 KG of okra seeds, 800 KG of sorghum, 200 KG of corn, 100 KG of glutinous rice, and 100 KG of Job's tears were weighed, and cleaned with clear water to remove dust and impurities on the surface;

Step 2): Drying and Sterilization

A drying oven was used to sterilize and dry the spare raw materials in Step 1), the temperature of the drying oven was controlled at 130° C. to keep the surface of the raw materials free from any residual water stains;

Step 3): Crushing

The dried and sterilized raw materials were crushed using a grinder, with a particle size of 10 mesh after crushing;

Step 4): Mixing

25° C. clear water was added to the crushed raw material in Step 3), after mixing, hold tightly and loosed into a scattered state. A mixer was used to stir at a constant speed for 20 minutes;

Step 5): Cooking

The well mixed ingredients of Step 4) were put into a steamer and steamed for 50 minutes, the temperature was controlled at 110° C., and steamed thoroughly, after steaming thoroughly, there was no hardness feel to the hand and no paste;

Step 6): Cooling and Drying

The steamed raw materials were placed in Step 5) in a sterile room for cooling, or external wind was used to cool, to reduce their temperature to 26° C., after cooling, the raw materials are dried, and the moisture content of the raw materials was controlled to 65%;

Step 7): Mixing Koji

The raw materials with adjusted humidity were subjected to koji mixing and put into a fermentation tank, covered with clean kraft paper and a food grade plastic film, fermented for 35 to 90 days for lipidation;

Step 8): Distillation

The fermented raw materials were put into a steamer for steaming, and the raw liquor was extracted;

Step 9): Storage

The raw liquor was put into a liquor jar and stored in a liquor cellar. The temperature of the liquor cellar was controlled at 10-20° C. and the humidity was controlled at 60-80° C. to make it mature, fragrant, and odorless. The flavor of liquor is mainly composed of fatty acids and other microorganisms. During the storage of liquor, fatty acid reactions constantly occur to produce substances with aromatic smell, so as to make the liquor more mellow. When the reaction of fatty acids and other microorganisms stopped, the liquor was in the best drinking period, and the storage time was at least 3 years, the specific storage time was controlled according to actual requirement, and the longer the storage time, the better the quality.

### Example 3

An okra liquor included the following raw materials in parts by weight: 40 parts of okra seeds, 100 parts of sorghum, 30 parts of corn, 20 parts of glutinous rice, 20 parts of Job's tears, and 50 parts of clear water.

A method for brewing the aforementioned okra liquor included the following steps:

Step 1): Material Selection

400 KG of okra seeds, 1000 KG of sorghum, 300 KG of corn, 200 KG of glutinous rice, and 200 KG of Job's tears were weighed, and cleaned with clear water to remove dust and impurities on the surface;

Step 2): Drying and Sterilization

A drying oven was used to sterilize and dry the spare raw materials in Step 1), the temperature of the drying oven was controlled between 110 and 160° C. to keep the surface of the raw materials free from any residual water stains;

Step 3): Crushing

The dried and sterilized raw materials were crushed using a grinder, with a particle size of 10 mesh after crushing;

Step 4): Mixing

25° C. clear water was added to the crushed raw material in Step 3), after mixing, hold tightly and loosed into a scattered state, a mixer was used to stir at a constant speed for 20 minutes;

Step 5): Cooking

The well mixed ingredients of Step 4) was put into a steamer and steamed for 60 minutes, the temperature was controlled at 120° C., and steamed thoroughly, after steaming thoroughly, there was no hardness feel to the hand and no paste;

Step 6): Cooling and Drying

The steamed raw materials in Step 5) were placed in a sterile room for cooling, or external wind was use to cool, reduced temperature to 26° C., after cooling, the raw materials were dried, and the moisture content of the raw materials was controlled to 70%;

Step 7): Mixing Koji

The raw materials with adjusted humidity were subjected to koji mixing and put into a fermentation tank, covered with clean kraft paper and a food grade plastic film, ferment for 35 to 90 days for lipidation;

Step 8): Distillation

The fermented raw materials were put into a steamer for steaming, and the raw liquor was extracted;

Step 9): Storage

The raw liquor was put into the liquor jar and stored in the liquor cellar. The temperature of the liquor cellar was controlled at 10-20° C. and the humidity was controlled at 60-80° C. to make it mature, fragrant, and odorless. The flavor of liquor is mainly composed of fatty acids and other microorganisms. During the storage of liquor, fatty acid reactions constantly occur to produce substances with aromatic smell, so as to make the liquor more mellow. When the reaction of fatty acids and other microorganisms stopped, the liquor was in the best drinking period, and the storage time was at least 3 years. The specific storage time can be controlled according to actual needs, and the longer the storage time, the better the quality.

For those skilled in the art, it is evident that the present disclosure is not limited to the details of the exemplary embodiments mentioned above, and can be implemented in other specific forms without departing from the spirit or basic features of the present disclosure. Therefore, from any perspective, embodiments should be regarded as exemplary and non-restrictive. The scope of the present disclosure is limited by the accompanying claims rather than the above description, and therefore aims to include all variations within the meaning and scope of the equivalent elements of the claims within the present disclosure.

In addition, it should be understood that although the specification is described according to the implementation mode, not each embodiment only includes an independent technical solution. This description method of the specification is only for clarity. Those skilled in the art should treat the specification as an entirety and the technical solutions in each embodiment can also be appropriately combined to form other implementation modes that can be understood by those skilled in the art.

What is claimed is:

1. An okra liquor, comprising the following raw materials in parts by weight: 20-40 parts of okra seeds, 60-100 parts of sorghum, 10-30 parts of corn, 5-20 parts of glutinous rice, 5-20 parts of Job's tears, and 50-80 parts of clear water.

2. The okra liquor according to claim 1, comprising the following raw materials in parts by weight: 20 parts of okra seeds, 60 parts of sorghum, 10 parts of corn, 5 parts of glutinous rice, 5 parts of Job's tears, and 60 parts of clear water.

3. The okra liquor according to claim 1, comprising the following raw materials in parts by weight: 30 parts of okra seeds, 80 parts of sorghum, 20 parts of corn, 10 parts of glutinous rice, 10 parts of Job's tears, and 50 parts of clear water.

4. The okra liquor according to claim 1, comprising the following raw materials in parts by weight: 40 parts of okra seeds, 100 parts of sorghum, 30 parts of corn, 20 parts of glutinous rice, 20 parts Job's tears, and 40 parts of clear water.

5. A brewing process for preparing the okra liquor according to claim 1, comprising the following steps:
Step 1): Material selection
Weighing an amount of okra seeds, sorghum, corn, glutinous rice, and Job's tears, and cleaning with clear water to remove dust and impurities on the surface;
Step 2): Drying and sterilization
Using a drying oven to sterilize and dry the spare raw materials in step 1), and controlling a temperature of the drying oven at 110-160° C.;
Step 3): Crushing
Crushing the dried and sterilized raw materials using a grinder, with a particle size of 10 mesh after crushing;
Step 4): Mixing
Adding the crushed raw materials in Step 3) to the clear water at a temperature of 20-28° C., and stirring at a constant speed for 20 minutes using a mixer;
Step 5): Cooking
Putting the well mixed raw materials of Step 4) into a steamer and cooking for 40-60 minutes, with a temperature controlled at 100-120° C., until the raw materials are fully steamed;
Step 6): Cooling and drying
Placing the raw materials after cooking in Step 5) in a sterile room for cooling, or cooling by using external wind to lower the temperature to 26° C., after cooling, drying appropriately and controlling the moisture content of the raw materials to 60-70%;
Step 7): Mixing koji
performing koji mixing on the raw materials with adjusted humidity and putting the raw materials into a fermentation tank, covering the raw materials with clean kraft paper and a food grade plastic film, fermenting for 35 to 90 days for lipidation;
Step 8): Distillation
Putting the fermented raw materials into a steamer for steaming, and extracting the original liquor;
Step 9): Storage
Placing the raw liquor in a liquor jar and stored in a liquor cellar, controlling a temperature of the liquor cellar at 10-20° C. and a humidity at 60-80° C., and storing for at least 3 years.
